(19) United States
(12) Patent Application Publication
(10) Pub. No.: US 2025/0163986 A1
(43) Pub. Date: May 22, 2025

(54) MOTOR VEHICLE VIBRATION DAMPER WITH A PROTECTIVE TUBE

(71) Applicant: ZF Friedrichshafen AG, Friedrichshafen (DE)

(72) Inventor: Carolin ARZBERGER, Thiersheim (DE)

(21) Appl. No.: 18/948,679

(22) Filed: Nov. 15, 2024

(30) Foreign Application Priority Data
Nov. 17, 2023 (DE) 10 2023 211 470.4

(51) Int. Cl. F16F 9/32

(52) U.S. Cl. CPC F16F 9/3235; F16F 2230/0005; F16F 2230/30

(57) ABSTRACT

A vibration damper has a damper cylinder closed at one end by a piston rod guide, an axially movable piston rod is guided through the piston rod guide, a protective tube is connected to and circumferentially surrounds the piston rod, and a guide component is arranged between the damper cylinder and the protective tube and guides the protective tube along the damper cylinder. The guide component has a fastening and an extension portion which extends axially from the fastening portion. The guide component is supported by its fastening portion at the damper cylinder in a positively engaging manner, and the guide component extends axially along the damper cylinder, the extension portion is arranged at the end of the guide component closest to the piston rod guide, and the fastening portion is arranged at the end of the guide component remote of the piston rod guide.

### BACKGROUND OF THE INVENTION

### 1. Field of the Invention

The disclosure is directed to a motor vehicle vibration damper.

### 2. Description of Related Art

A generic vibration damper is well known from the prior art.

DE10122796A1 shows, by way of example, a motor vehicle vibration damper which comprises a damper cylinder which is closed at its axial end by a piston rod guide. A piston rod which is configured to be axially movable relative to the damper cylinder is partially guided out through the piston rod guide. This piston rod is covered in circumferential direction by a protective tube, and this protective tube is connected to the piston rod. A guide component which guides the protective tube axially along the damper cylinder is arranged radially between the damper cylinder and the protective tube. The guide component is substantially cup-shaped, the base of the cup overlaps the piston rod guide and the cup wall extends axially from the piston rod guide along the damper cylinder. In particular, the guide component is axially supported at the piston rod guide by the cup base. During compression movements of the piston rod, the cup base additionally serves as an impact surface for an impact absorber that is fixedly connected to the piston rod. Since the guide component is generally produced from a plastic, the cup base must be especially robust in order to withstand the impact of the impact absorber during abrupt compressions of the piston rod. Therefore, during an above-average high load of this type, a premature material fatigue and breakage of the cup base cannot be entirely ruled out.

### SUMMARY OF THE INVENTION

Therefore, it is the object of one aspect of the invention to provide a motor vehicle vibration damper which overcomes the disadvantage described above.

According to one aspect of the invention, the guide component comprises a fastening portion and an extension portion which extends axially from the fastening portion, the guide component is radially supported by its fastening portion at the damper cylinder and/or is connected to the damper cylinder in a positively engaging and/or frictionally engaging and/or bondingly engaging manner, and the guide component is arranged at the damper cylinder in such a way that it extends axially along the damper cylinder in the installed state. The extension portion is arranged at the end of the guide component closest to the piston rod guide, and the fastening portion is arranged at the end of the guide component remote of the piston rod guide.

Accordingly, the piston rod guide is no longer concealed by the guide component and is not exposed to the impact of the impact absorber. The piston rod guide, which is made of metal, can withstand the impact force of the impact absorber. Beyond this, a possibility is also furnished during particularly high loads to utilize an additional impact disk which is made of a metal and which can then be mounted at the end of the damper cylinder on the piston rod guide side in order to additionally protect the piston rod guide.

A generic motor vehicle vibration damper often comprises a spring plate which is arranged at the damper tube and which supports a bearing spring. In order to prevent an axial slippage of the guide component, this spring plate can advantageously be arranged in such a way that the guide component is additionally axially supported at the spring plate by its fastening portion.

The guide component can generally be formed to be substantially tubular. Additionally or alternatively, however, the extension portion can advantageously be formed from a plurality of webs extending axially from the fastening portion with axially extending free spaces between the webs in order to economize on material and weight.

In order to impart greater stiffness to the guide component in the region of the extension portion, it is provided according to an advantageous constructional variant to connect at least two webs to one another at their ends remote of the fastening portion.

Beyond this, when a fixed positively engaging connection of the guide component to the damper cylinder is required, the fastening portion can advantageously be formed as a closed ring.

If an easier installation of the guide component is to be prioritized, the fastening portion of the guide component can be formed as a discontinuous ring broken by at least one discontinuity location.

If it is desirable to avoid a guide component that is slit along its entire length to ensure the radial stability of the component, the discontinuity location can advantageously be arranged at the fastening portion in each instance between two webs of the guide component which are connected to one another.

According to a further advantageous constructional variant, the fastening portion can comprise a plurality of discontinuity locations which are arranged at the fastening portion in such a way that the guide component extends overall meanderingly around the damper cylinder. In this way, manufacturing tolerances with respect to the diameter of the damper tube can be compensated in an appreciably simpler manner. Accordingly, the mounting of the guide component at the damper tube can be substantially facilitated and any differences in diameter can be compensated in a simple manner.

Further, in order to facilitate the installation of the guide component at the damper cylinder, the guide component can advantageously have radially inwardly protruding ribs which extend axially along the fastening portion and/or at least partially along the webs. This reduces the contact surface of the guide component, which appreciably reduces the frictional forces occurring between the guide component and the damper cylinder when installing the guide component. This facilitates the installation of the guide component at the damper cylinder and reduces the risk of damaging the surface coating on the damper cylinder.

In principle, the construction of the guide component can be adapted to the construction of the motor vehicle vibration damper. Accordingly, it is provided in a further advantageous constructional variant that the extension portion is divided into a plurality of, but at least two, axial length portions of different diameters which are connected to one another, respectively, by a connection portion. In particular, it can be important to adapt the diameter of the guide component to the end of the extension portion thereof closest to the piston rod guide, for example, to the size of an impact disk, in order to prevent a direct collision of the protective tube with the guide component.

### BRIEF DESCRIPTION OF THE DRAWINGS

Further features, advantages and effects of the invention will be apparent from the following description of preferred embodiment examples of the invention. The drawings show:

FIG. 1 is a perspective view of a first constructional variant of a motor vehicle vibration damper;

FIG. 2 a view of a motor vehicle vibration damper according to FIG. 1 without the protective tube;

FIG. 3 a longitudinal sectional view of the guide component according to FIG. 1;

FIG. 4 a cross-sectional view of the guide component according to FIG. 3 in cross section through the fastening portion;

FIG. 5 a view of a further constructional variant of a motor vehicle vibration damper without the protective tube;

FIG. 6 a longitudinal sectional view of the guide component according to FIG. 5; and

FIG. 7 a cross-sectional view of the guide component according to FIG. 6 in cross section through the fastening portion.

### DETAILED DESCRIPTION OF THE PRESENTLY PREFERRED EMBODIMENTS

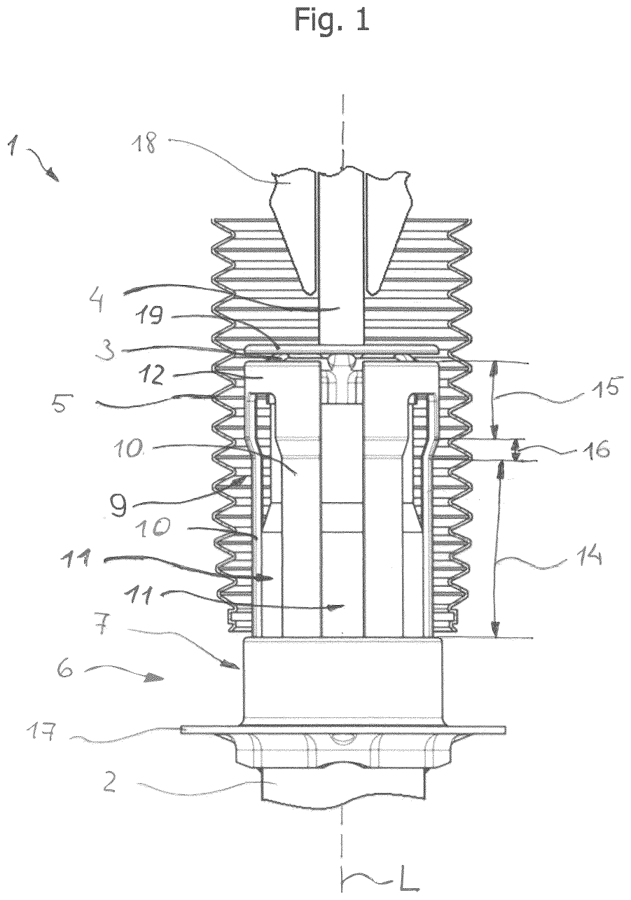

FIG. 1 shows a constructional variant of a motor vehicle vibration damper 1 constructed according to the present invention. It comprises a damper cylinder 2 which is closed at the axial end thereof by a piston rod guide 3 and is covered by an impact disk 19. Also shown is a piston rod 4 partially guided out through the piston rod guide 3 and the impact disk 19. The piston rod 4 is formed axially movable relative to the damper cylinder 2 and telescopes partially into and out of the damper cylinder 2 when excited by road irregularities over which the motor vehicle drives during operation. During strong compression movements of the piston rod 4, these inward movements are stopped by the resilient impact absorber 18 which is fixedly connected to the piston rod 4 and which comes to a stop at the impact disk 19.

A protective tube 5 is fixedly connected to the piston rod 4 and protects the latter from external influences. The protective tube 5 illustrated in FIG. 1 has a plurality of elastic folds which extend in circumferential direction around the protective tube 5 and are distributed along at least a defined length portion of the protective tube 5.

However, it is not intended that the present invention be limited to the construction of the protective tube 5 shown in FIG. 1, since the invention is likewise usable and applicable with any other construction of the protective tube 5.

In order that no direct contact occurs between the protective tube 5 and the damper cylinder 2, as result of which the surface coating of the damper cylinder 2 could be damaged, the motor vehicle vibration damper 1 shown in FIG. 1 further comprises a guide component 6 which is arranged radially between the damper cylinder 2 and the protective tube 5, surrounds the damper cylinder 2 in circumferential direction and axially guides the protective tube 5 along the damper cylinder 2.

The guide component 6 comprises a fastening portion 7 and an extension portion 9 axially extending from the fastening portion 7. The fastening portion 7 of the guide component 6 is supported radially at the damper cylinder 2 and/or is connected to the damper cylinder 2 in a positively engaging and/or frictionally engaging and/or bondingly engaging manner.

The guide component 6 extends axially along the damper cylinder 2 in the installed state, and the extension portion 9 is arranged at the end of the guide component 6 closest to the piston rod guide, and the fastening portion 7 is arranged at the end of the guide component 6 remote of the piston rod. The outer constructional form of the guide component 6 in the variant illustrated in FIG. 1 is adapted to the outer shape of the damper cylinder 2. The extension portion 9 is divided into two axial length portions 14, 15 which are connected to one another, respectively, by a connection portion 16. The first axial length portion 14 extends axially from the fastening portion 7 in direction of the piston rod and has a smaller diameter than the second axial length portion 15 which extends up to the impact disk 19.

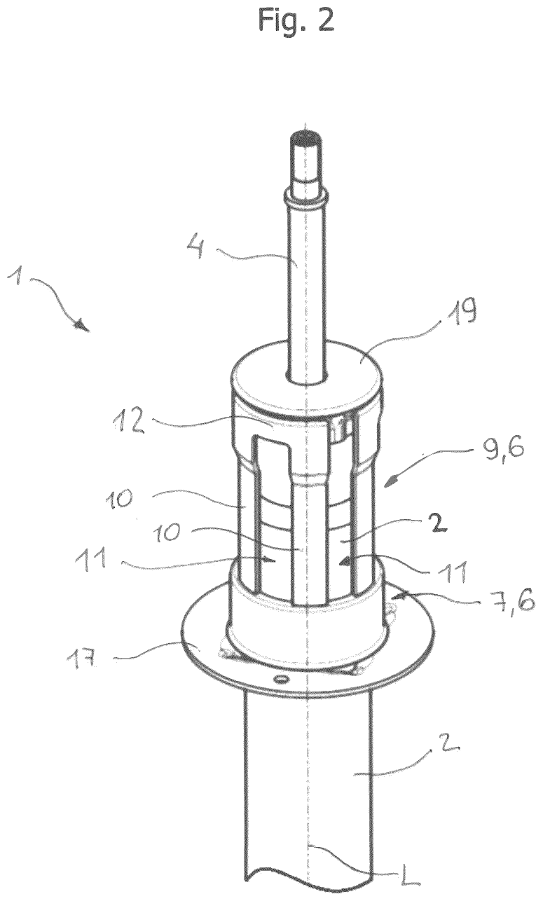

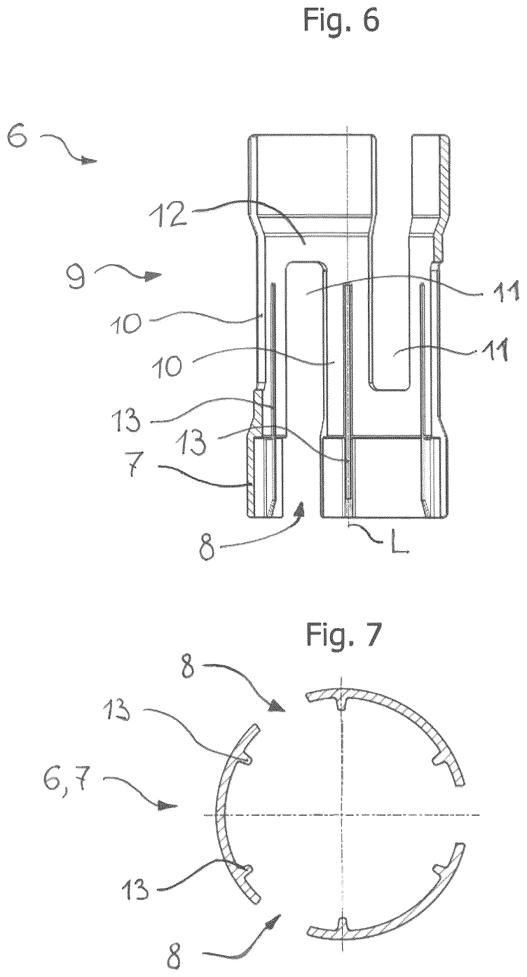

Beyond this, FIGS. 1, 2, and 5 show that the motor vehicle vibration damper 1 comprises a spring plate 17, which serves primarily to axially support a bearing spring, not shown. The spring plate 17 is arranged at the damper cylinder 2 and is connected to the damper cylinder 2 so as to be axially fixed and secured against rotation. The guide component 6 is axially supported by its fastening portion 7 at the spring plate 17. The extension portion 9 of the guide component 6 surrounds the damper cylinder 2 in circumferential direction and is formed of a plurality of webs 10 which extend axially from the fastening portion 7 and extend in direction of the piston rod guide 3. The individual webs 10 are separated from one another by free spaces 11 running axially along the webs 10. In the constructional variants shown in FIGS. 1, 2, 3, 5, and 6, two webs 10 are connected to one another in each instance at their ends remote of the fastening portion at a connection location 12 in each instance.

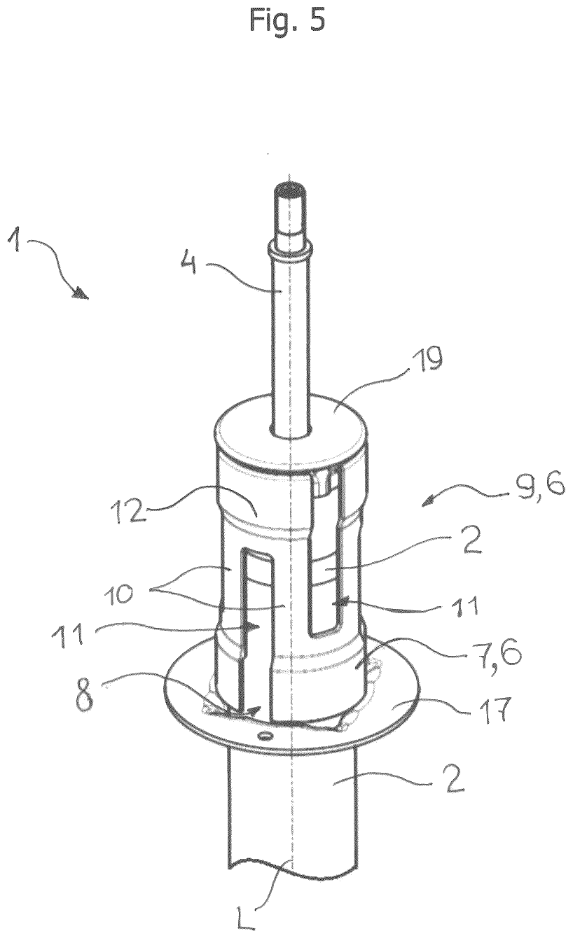

FIGS. 1 to 4 show a constructional variant of the motor vehicle vibration damper which provides that the fastening portion 7 is formed as a closed ring. In contrast, FIGS. 5 and 7 show an alternate construction according to which the substantially annular fastening portion 7 is formed discontinuously by at least one discontinuity location 8. The discontinuity location 8 is arranged between two webs 10 of the guide component 6 which are connected to one another.

In particular, FIG. 7 shows that the fastening portion 7 can likewise comprise a plurality of discontinuity locations 8. These discontinuity locations 8 can be arranged at the fastening portion 7 in such a way that the guide component 6 extends overall in a meandering manner around the damper cylinder 2.

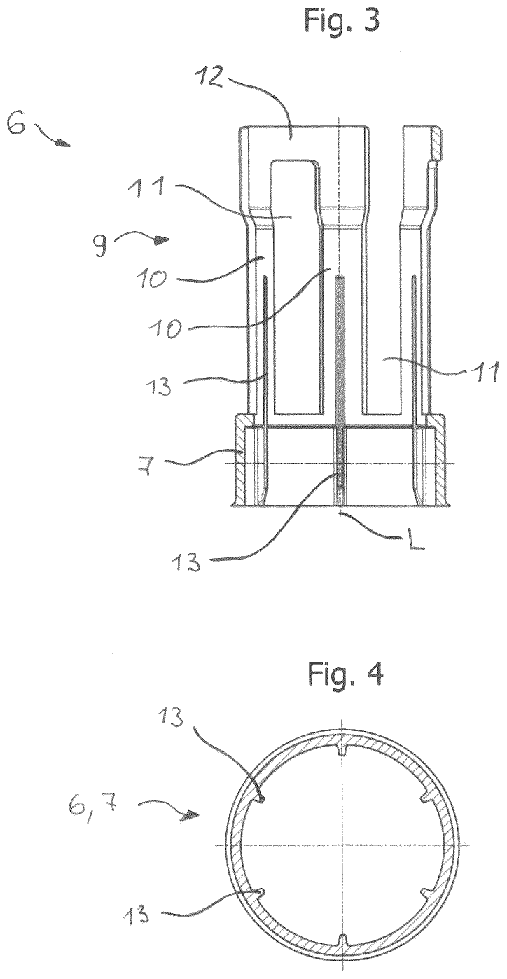

According to the embodiments illustrated in FIGS. 3, 4, 6, and 7, the guide component 6 can have radially inwardly protruding ribs 13. The ribs 13 extend axially along the fastening portion 7 and/or at least partially along the webs 10.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A motor vehicle vibration damper, comprising:
a piston rod guide;
a damper cylinder which is closed at least at one of its axial ends by the piston rod guide;
a piston rod which is partially guided out through the piston rod guide and is configured to be axially movable relative to the damper cylinder;
a protective tube which is connected to the piston rod and circumferentially surrounds the piston rod; and
a guide component that extends axially along the damper cylinder in an installed state and which is radially arranged between the damper cylinder and the protective tube and axially guides the protective tube along the damper cylinder, the guide component comprises:
a fastening portion arranged at an end of the guide component remote of the piston rod guide; and
an extension portion arranged at an end of the guide component closest to the piston rod guide, which extends axially from the fastening portion;
wherein the guide component is radially supported by the fastening portion at the damper cylinder and/or is connected to the damper cylinder in a positively engaging and/or frictionally engaging and/or bondingly engaging manner.

2. The motor vehicle vibration damper according to claim 1, further comprising:
a spring plate which is arranged at the damper cylinder,
wherein the guide component is axially supported at the spring plate by its fastening portion.

3. The motor vehicle vibration damper according to claim 1, wherein the extension portion of the guide component is formed from a plurality of webs axially extending from the fastening portion.

4. The motor vehicle vibration damper according to claim 3, wherein at least two webs in each instance are connected to one another at their ends remote of the fastening portion.

5. The motor vehicle vibration damper according to claim 1, wherein the fastening portion is formed as a closed ring.

6. The motor vehicle vibration damper according to claim 1, wherein the fastening portion is formed as a discontinuous ring interrupted by at least one discontinuity location.

7. The motor vehicle vibration damper according to claim 6, wherein the at least one discontinuity location is arranged at the fastening portion in each instance between two webs of the guide component which are connected to one another.

8. The motor vehicle vibration damper according to claim 7, wherein the fastening portion comprises a plurality of discontinuity locations which are arranged at the fastening portion in such a way that the guide component extends overall meanderingly around the damper cylinder.

9. The motor vehicle vibration damper according to claim 3, wherein the guide component has radially inwardly protruding ribs which extend axially along the fastening portion and/or at least partially along the plurality of webs.

10. The motor vehicle vibration damper according to claim 1, wherein the extension portion is divided into at least two axial length portions of different diameters which are connected to one another, respectively, by a connection portion.
